(19) United States
(12) Patent Application Publication
(10) Pub. No.: US 2016/0222716 A1
(43) Pub. Date: Aug. 4, 2016

(54) MULTI-STAGE VERTICAL OPEN/CLOSE-TYPE SCREEN DOOR OPERATED BY MOVING PULLEY

(71) Applicant: THE KOREA TRANSPORT INSTITUTE, Gyeonggi-do (KR)

(72) Inventors: Hyun KIM, Seoul (KR); Pan Ju SHIN, Daejeon (KR)

(21) Appl. No.: 15/021,747

(22) PCT Filed: Sep. 11, 2014
(86) PCT No.: PCT/KR2014/008493

§ 371 Date: Mar. 14, 2016

(30) Foreign Application Priority Data
Sep. 12, 2013 (KR) 10-2013-0109886
Mar. 18, 2014 (KR) 10-2014-0031833

(51) Int. Cl. E06B 3/44; E05D 13/00; B61B 1/02; E05D 15/16

(52) U.S. Cl. CPC E06B 3/4415; E06B 3/44; E05D 15/165; E05D 13/00; B61B 1/02; E05Y 2900/404

(57) ABSTRACT

The present invention relates to a platform screen door including: a main body including a pair of vertical frames; a first door and a second door disposed between the pair of vertical frames; a first moving pulley connected to the second door so as to vertically move the second door; a first connector for driving the first moving pulley; and a driving assembly for driving the first connector, the driving assembly being installed on the main body, wherein the first door is fixed and connected to one spot of a driving segment of the first connector.

### TECHNICAL FIELD

The present invention relates to a screen door of a platform, and more particularly, a technology relating to a screen door that is opened and closed in a vertical direction.

### BACKGROUND ART

Passengers waiting on the platform for the train may drop to a railroad or be bumped to the moving train. To solve the foregoing problem, a platform screen door that is vertically opened and closed may be installed between the platform and the railroad. In this specification, the “platform screen door” may be called a screen door, a platform safety device, a platform safety door, or a platform screen device.

A technology relating to a vertical open/close-type platform screen door is published in Korean Patent Registration No. 10-0601112. The platform screen door according to the foregoing technology includes a plurality of main bodies installed on both ends of a platform, a screen door vertically moved along the main bodies, and a driver for vertically moving the screen door. Here, the screen door has a shape that lengthily extends in a left/right direction. Also, the screen door may be constituted by a plurality of doors including a first door extending in the left/right direction and a second door disposed on a lower or upper portion of the first door to extend in the left/right direction. The vertical open/close-type platform screen door may be used for a platform at which various kinds of trains stop.

However, when the method disclosed in the foregoing registration patent is used, the upper door may be caught by the lower door to ascend. Thus, an impact may occur at a moment at which the two doors that are vertically adjacent to each other collide with each other. Also, since the two doors are driven by separate driving members, a driving assembly may be complicated.

### DISCLOSURE OF THE INVENTION

### Technical Problem

The present invention is to provide a technology in which two screen doors are continuously and vertically moved without generating an impact therebetween in a vertical open/close-type platform screen door including the two screen doors that are vertically adjacent to each other.

### Technical Solution

To solve the foregoing object, a platform screen door according to one aspect of the present invention includes: a main body including a pair of vertical frames (100, 200); a first door (30) and a second door (20), which are disposed between the pair of vertical frames; a moving pulley (3191) coupled to the second door to vertically move the second door; a first connector (3019) driving the moving pulley; and a driving assembly (4100) driving the first connector, the driving assembly being installed on the main body, wherein the first door is fixed and connected to one spot of the driving assembly of the first connector.

Here, the platform screen door may further include a first pulley (3192). Also, the first pulley may be rotatably coupled to the second door, and the first connector may include a belt for connecting the moving pulley to the first pulley.

Here, the second door may receive vertical force from the first door through the moving pulley.

Here, the first door and the second door may be moved along a rail provided on the vertical frame.

Here, the platform screen door may further include: a horizontal frame (300) disposed on upper portions of the pair of vertical frames; and one driving part installed on the main body to drive the driving assembly through the horizontal connector (302). Also, the driving assembly may include: a left driving assembly installed on a left vertical frame (100) of the pair of vertical frames to vertically move a left end of the first door; and a right driving assembly installed on a right vertical frame of the pair of vertical frames to vertically move a right end of the first door. Also, the left driving assembly and the right driving assembly may be driven at the same time by the one driving part.

Here, the horizontal connector may include a belt, a chain, or a rope and is disposed to extend along the horizontal frame, and a pulley (1042) for preventing the horizontal connector from drooping may be installed on the horizontal frame.

Here, the driving assembly may include: a pair of pulleys (142, 143); a vertical connector (144) rotated by the pair of pulleys; a first slit (31) defined in the vertical frame; and a first block (32) for fixing and coupling a portion of the vertical connector to the first door, the first block being vertically moved along the first slit.

Here, a rotation shaft (130) of the upper pulley (142) of the pair of pulleys may be coupled to the horizontal connector so as to be rotated by the horizontal connector.

Here, the platform screen door may further include: a first block (32) connected to left and right sides of the first door; and a second block (22) connected to left and right sides of the second door, the second block including a first moving pulley. Also, the first connector may transmit vertical force from the first block to the second block through the moving pulley.

Here, a first coupling part (3193) disposed on the first block may be fixed and coupled to a portion of the first connector.

Here, the left driving assembly may include: a left vertical connector (144); and a left first block (32) for fixing and coupling a portion of the left vertical connector to the left end of the first door. Also, the right driving assembly may include: a right vertical connector; and a right first block for fixing and coupling a portion of the right vertical connector to the right end of the first door. Also, the left end of the first door may be fixed and coupled to a first spot of the left vertical connector, and the right end of the first door may be fixed and coupled to a second spot of the right vertical connector. Also, the first and second spots may be selected to be always directed in the same direction.

Here, all of the left driving assembly and the right driving assembly may be disposed on a side of a platform or a side of a railroad.

Here, the platform screen door may further include: a third door (10) disposed between the pair of vertical frames; a pair of second pulleys (132, 133) installed on the pair of vertical frames; and a second vertical connector (134) rotated by the pair of second pulleys. Also, when the platform screen door is closed, the third door may be disposed at a position higher than that of the second door. Also, a first portion of the third door may be relatively fixed to a first portion of the second vertical connector so as to be vertically moved according to rotation of the second vertical connector.

A platform screen door according to another aspect of the present invention includes: first, second, and third doors disposed between a pair of vertical frames; first, second, and third hangers respectively connected to left and side sides of the first, second, and third doors; a first moving pulley coupled to the second hanger to vertically move the second door; a second moving pulley coupled to the third hanger to vertically move the third door; and first and second connectors for respectively driving the first and second moving pulleys. Here, the first hanger may be fixed and coupled to one spot of a first driving segment of the first connector, and the second hanger may be fixed and coupled to one spot of a second driving segment of the second connector.

Here, the platform screen door may further include a first pulley. Also, the first pulley may be rotatably coupled to the second hanger. Also, the first connector may be a belt for connecting the first moving pulley to the first pulley.

Here, the platform screen door may further include a second pulley. Also, the second pulley may be rotatably coupled to the third hanger. Also, the second connector may be a belt for connecting the second moving pulley to the second pulley.

Here, a first coupling part disposed on the first hanger may be fixed and coupled to a portion of the first connector, and a second coupling part disposed on the third hanger may be fixed and coupled to a portion of the second connector.

Here, the first hanger, the second hanger, and the third hanger may be moved along rails provided on the vertical frame.

### Advantageous Effects

According to the present invention, in the vertical open/close-type platform screen door including the two screen doors that are vertically adjacent to each other, the two screen doors may be connected to each other by using the moving pulley to continuously and vertically move the two screen doors without generating the impact therebetween.

### BRIEF DESCRIPTION OF THE DRAWINGS

FIG. 1 is an exploded perspective view of a platform screen door according to Embodiment 1 of the present invention.

FIG. 2 is a partial enlarged view of a portion A of FIG. 1.

FIG. 3 is a partial enlarged view of a portion B of FIG. 1.

FIG. 4 is an enlarged view of a hanger of FIG. 1.

FIG. 5 is a view illustrating a state in which the plurality of hangers of FIG. 1 are arranged in parallel.

FIG. 6 is a partial enlarged view of a portion C of FIG. 1.

FIG. 7 is an exploded perspective view of a platform screen door according to Embodiment 2 of the present invention.

FIG. 8 is a partial enlarged view of a portion D of FIG. 7.

FIG. 9 is a view for explaining a structure of a hanger of FIG. 7.

FIG. 10 is an enlarged view for explaining a state in which the plurality of hangers of FIG. 7 are coupled to be vertically spaced a predetermined distance from each other. Here, FIG. 10a illustrates a structure before the plurality of hangers are coupled to each other, and FIG. 10b illustrates a structure after the plurality of hangers are coupled to each other.

FIG. 11 is a view for explaining a structure in which the plurality of hangers 2171, 2172, and 2173 of FIG. 7 are coupled to each other.

FIG. 12 is a view illustrating a state in which the plurality of hangers 2171, 2172, and 2173 of FIG. 7 overlap each other.

FIG. 13 is a view illustrating a state in which the plurality of hangers 2171, 2172, and 2173 of FIG. 7 are vertically spaced a predetermined distance from each other.

FIG. 14 is a front view of a platform screen door according to Embodiment 3 of the present invention.

FIG. 15 is a bottom view of a platform screen door according to an embodiment of the present invention.

FIG. 16a is a partial enlarged perspective view of a left frame 100 of FIG. 14.

FIG. 16a is a partial perspective view of the left frame 100 of FIG. 14.

FIG. is a view of a structure of a side that is opposite to FIG. 16b.

FIG. 16d is a view illustrating a mutual connection relationship between three blocks supporting doors of FIG. 14.

FIG. 17 is a view illustrating portions of an upper end of the left frame 100 and a connection part of a horizontal frame 300 of FIG. 14.

FIG. 18a is a view of a second door 20 and a third door 30 of FIG. 14.

FIG. 18b is a detailed view of the second door 20 of FIG. 14.

FIG. 18c is a detailed view of the third door 30 of FIG. 14.

FIG. 18d is a cross-sectional view of a holder part 310 of FIG. 18c.

FIG. 18e is a front view of the holder part 310 of FIG. 18c.

FIG. 19 is a view illustrating an inner structure of a lower block 31 of FIG. 16a.

### MODE FOR CARRYING OUT THE INVENTION

Hereinafter, embodiments of the present invention will be described in detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Also, for convenience of description, the dimensions of elements are exaggerated or downscaled.

### Embodiment 1

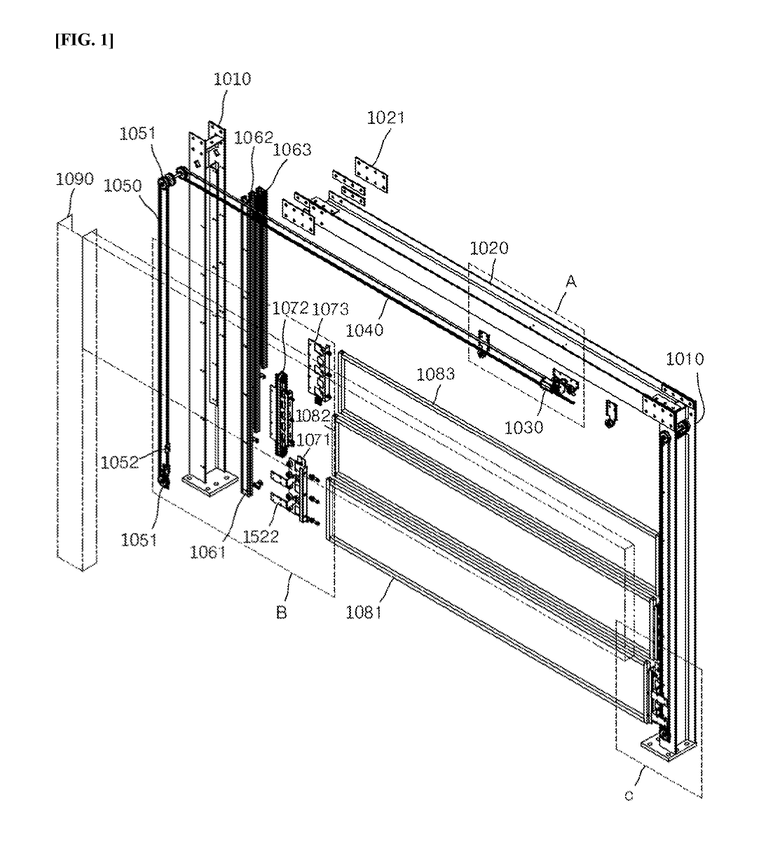

Hereinafter, Embodiment 1 of the present invention will be described with reference to FIGS. 1 to 6.

FIG. 1 is an exploded perspective view of a platform screen door 1100 according to Embodiment 1 of the present invention.

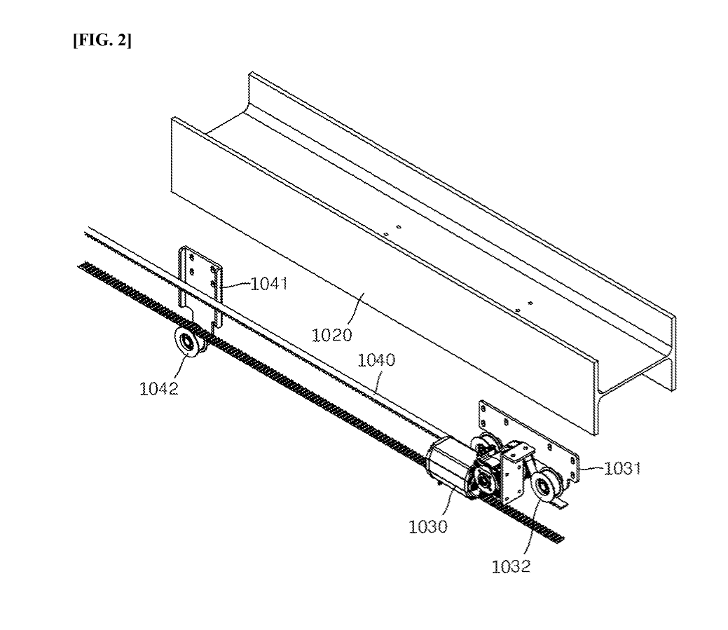

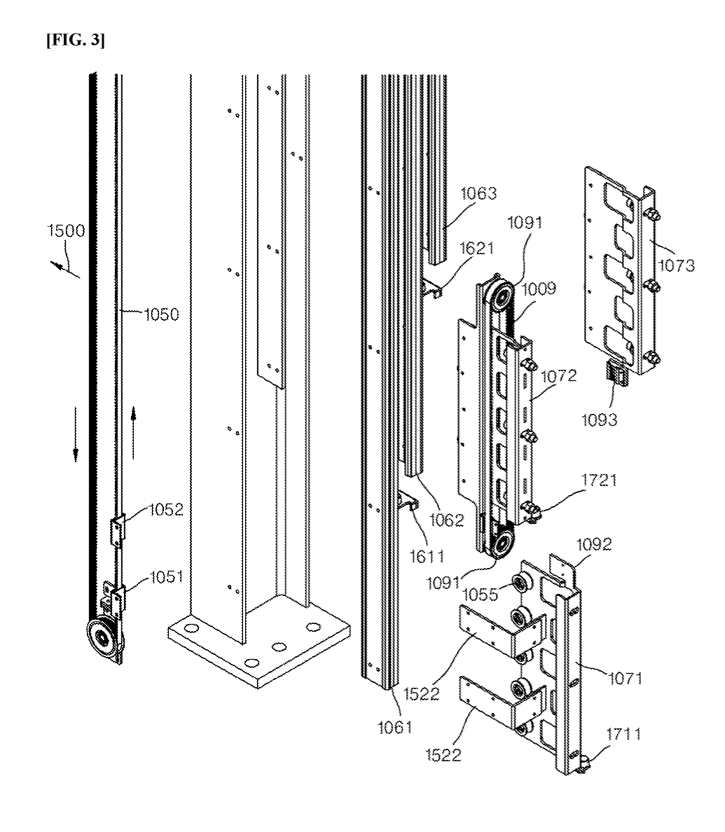

FIG. 2 is a partial enlarged view of a portion A of FIG. 1.

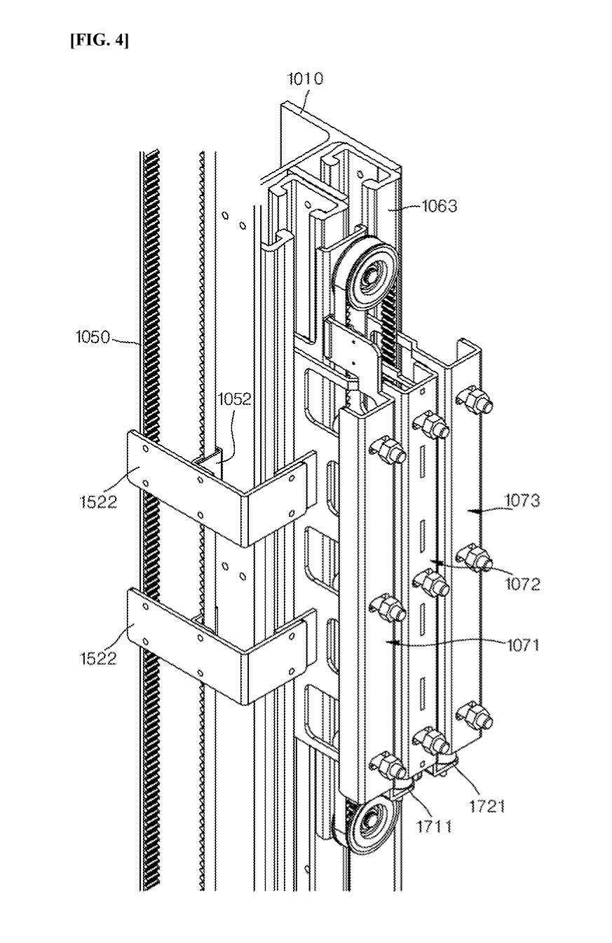

FIG. 3 is a partial enlarged view of a portion B of FIG. 1.

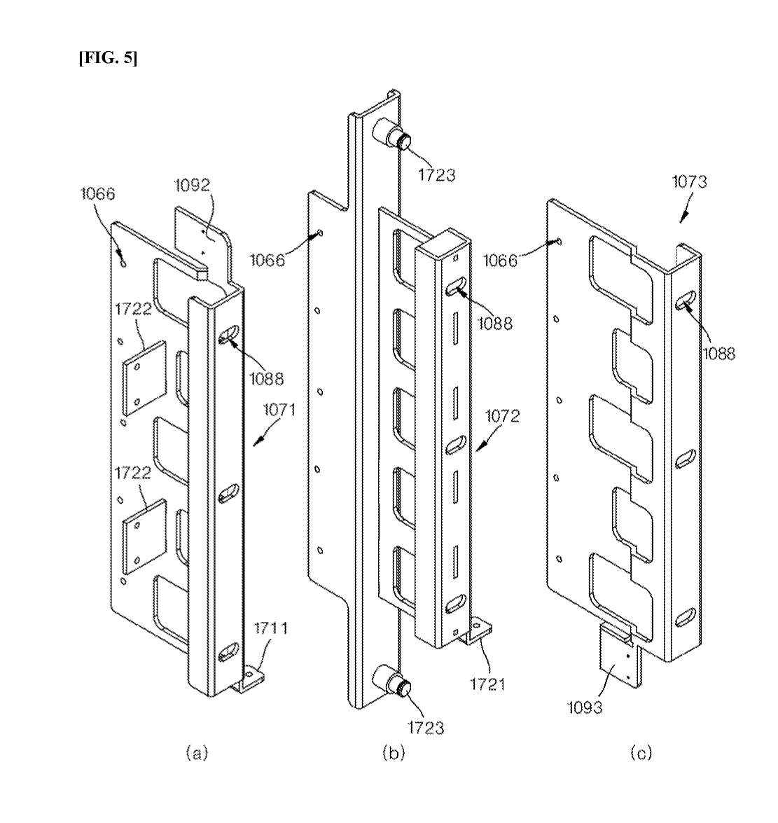

FIG. 4 is an enlarged view of a plurality of hangers 1071, 1072, and 1073 of FIG. 1.

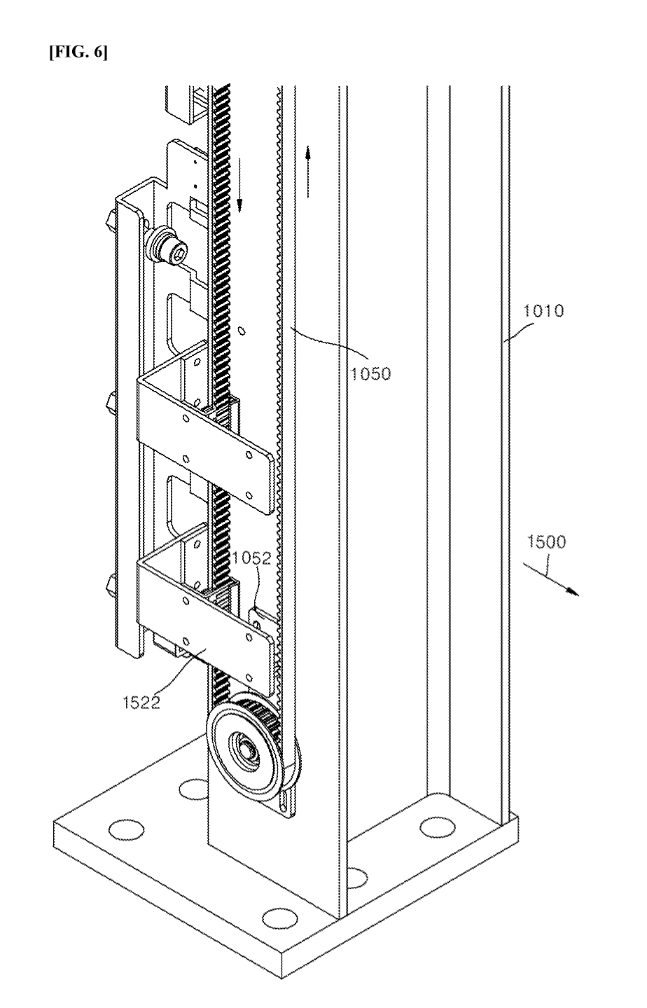

FIG. 5 is a view illustrating a state in which the plurality of hangers 1071, 1072, and 1073 of FIG. 1 are arranged in parallel.

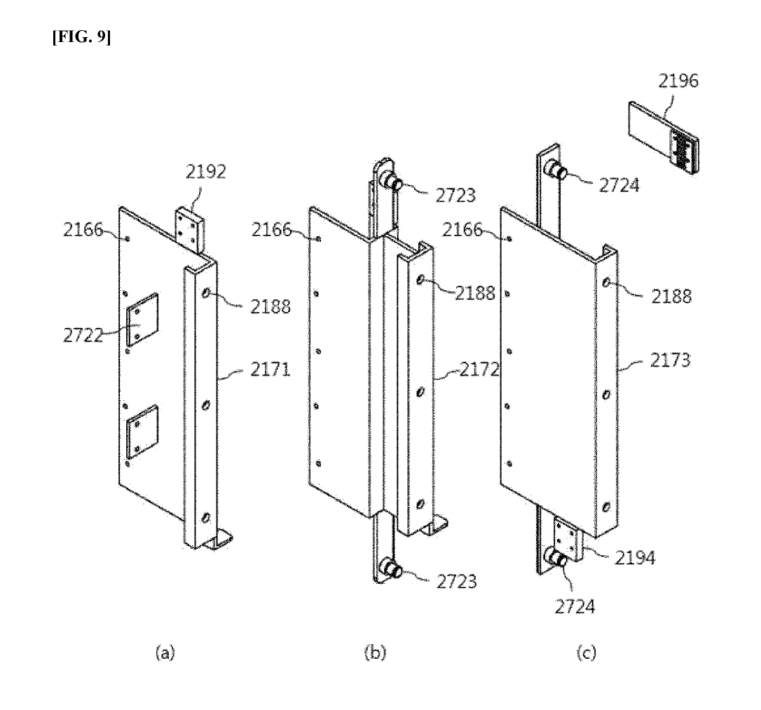

FIG. 8 is a partial enlarged view of a portion C of FIG. 1.

Hereinafter, the platform screen door 1100 according to Embodiment 1 of the present invention will be described with reference to FIGS. 1 to 5.

In the platform screen door 1100 according to Embodiment 1 of the present invention, a basic frame of the platform screen door 1100 includes a pair of vertical frames 1010 installed to be spaced apart from each other on a platform and two horizontal frames 1020 connecting upper ends of the pair of vertical frames 1010 to each other. The horizontal frames 1020 and the pair of vertical frames 1010 may be connected to each other by a connection reinforcing member 1021.

A torsion bracket 1031, a belt drooping prevention bracket 1041, and a driving part 1030 are fixedly installed on the horizontal frames 1020. The driving part 1030 may be coupled to a horizontal belt 1040 to rotate the horizontal belt 1040 in a clockwise or counterclockwise direction. Pulleys 1032 and 1042 may be installed to maintain tension of the horizontal belt 1040. The horizontal belt 1040 may rotate a rotation shaft to which the pulley 1051 is fixedly coupled and thus rotates the pulley 1051. In this specification, the horizontal belt 1040 may be substituted by a chain. The ‘horizontal belt’ or ‘chain’ may be commonly called a ‘horizontal connector’.

A pair of pulleys 1051 installed on one vertical frame 1010 is divided into an upper pulley 1051 and a lower pulley 1051. The vertical belt 1050 may be rotated in the clockwise or counterclockwise direction by the pair of pulleys 1051. That is, the moving direction of the vertical belt 1050 may be determined by the operation of the driving part 1030. Here, the vertical belt 1050 is constituted by a belt. On the other hand, the belt may be substituted by a chain or rope. In this specification, the vertical belt 1050 lengthily installed on the vertical frame 1010 in a vertical direction and the chain or rope that is an equivalent substitution component may be commonly called a ‘vertical connector’.

A clamp 1052 may be fixed and coupled to one spot of the vertical belt 1050. The clamp 1052 may be fixed and coupled to a clamp 1722 that is provided on a first hanger 1071 through a coupling piece 1522. Thus, the vertical belt 1050 may be moved by the operation of the driving part 1030, and the first hanger 1071 may be vertically moved by the same displacement as the one spot of the vertical belt 1050.

A first rail 1061, a second rail 1062, and a third rail 1063 are disposed on the vertical frame 1010. A first hanger 1071, a second hanger 1072, and a third hanger 1073 may be respectively coupled to the rail 1061, the second rail 1062, and the third rail 1063 and then be vertically moved. For this, at lest one roller 1055 may be coupled to each of the first hanger 1071, the second hanger 1072, and the third hanger 1073, and a shaft of the roller 1055 may be coupled to a roller hole 1066. In FIG. 3, rollers coupled to the second and third hangers 1072 and 1073 are not illustrated for convenience of description.

One left vertical frame 1010 and one right vertical frame 1010 may be coupled to each of the first hanger 1071, the second hanger 1072, and the third hanger 1073. A first door 1081, a second door 1082, and a third door 1083 may be coupled between the pair of first hangers 1071, between the pair of second hangers 1072, and between the pair of third hangers 1073, respectively. A door connection hole 1088 may be defined in each of the hanger 1071, the second hanger 1072, and the third hanger 1073. Thus, each of the first door 1081, the second door 1082, and the third door 1083 may be coupled to the door connection hole 1088.

A pulley shaft 1723 for a pulley 1091 may be disposed on each of upper and lower ends of the second hanger 1072. The pair of pulleys 1091 may be rotatably coupled to the pair of pulley shafts 1723. Also, a belt 1009 may be coupled to contact an outer surface of each of the pair of pulleys 1091. In this specification, the belt 1009 may be called a ‘rotation connector’. Also, the ‘rotation connector’ may be substituted by a chain in addition to the belt.

A first coupling part 1092 may be disposed on an upper end of the first hanger 1072m and a third coupling part 1093 may be disposed on a lower end of the third hanger 1073. The first coupling part 1092 may be fixed and coupled to one portion of the belt 1009, and the third coupling part 1093 may be fixed and coupled to the other portion of the belt 1009.

Hereinafter, movement principles of the hanger 1071, the second hanger 1072, and the third hanger 1073 according to the operation of the driving part 1030 will be described according to Embodiment 1 of the present invention.

When the driving 1030 is rotated, the horizontal belt 1040 is rotated in the clockwise (counterclockwise) direction. Thus, the pair of vertical belts 1050 coupled to the left vertical frame 1010 and the right vertical frame 1010 may also be rotated in the clockwise (counterclockwise) direction. The clamp 1052 fixed and coupled to the one spot of the vertical belt 1050 is moved along the vertical belt 1050. The first hanger 1071 fixed and coupled to the clamp 1052 through the coupling piece 1522 and the clamp 1052 is moved in the same direction as the clamp 1052.

Here, since the first coupling part 1092 of the first hanger 1071 and the belt 1009 are fixed and coupled to each other, the second hanger 1072 coupled to the belt 1009 through the pulley 1091 may be moved in the same direction as the first hanger 1071. Here, since the pair of moved pulleys 1091 (particularly, the lower pulleys) serve as a moving pulley (i.e., movable pulley), a vertical moving speed of the second hanger 1072 may be a half of a vertical moving speed of the first hanger 1071. Thus, when each of the first and second hangers 1071 and 1072 are disposed at the lowermost position, vertical central portions of the first and second hangers 1071 and 1072 are vertically spaced a predetermined distance from each other. Thus, as the first and second hangers 1071 and 1072 ascend upward, the distance between the vertical central portions may be reduced.

A first protrusion 1711 is disposed on the lower end of the first hanger 1071. Since the first and second hangers 1071 and 1072 are coupled to each other by the above-described moving pulley, the first hanger 1071 may ascend or descend at a speed that is double that of the second hanger 1072. Here, when the first protrusion 1711 is hung on the lower end of the second hanger 1072, the first and second hangers 1071 and 1072 may ascend at the same speed. Thus, the first hanger 1071 does not ascend up to a height that is greater than that of the second hanger 1072.

Also, a second protrusion 1721 is disposed on the lower end of the second hanger 1072. When the second hanger 1072 ascends up to a predetermined height, the second protrusion 1721 is hung on the lower end of the third hanger 1073. At this time, the third hanger 1073 may be coupled to the second hanger 1072 to ascend at the same speed as the second hanger 1072. Before this, the third hanger 1073 may be maintained in a stop state.

FIG. 4 illustrates a state in which the first protrusion 1711 is hung on the lower end of the second hanger 1072, and the second protrusion 1721 is hung on the lower end of the third hanger 1073. At this time, the first hanger 1071, the second hanger 1072, and the third hanger 1073 may ascend in a mutually overlapping state.

On the other hand, when each of the first hanger 1071, the second hanger 1072, and the third hanger 1073 is disposed at the lowermost position, the first hanger 1071, the second hanger 1072, and the third hanger 1073 may be maintained to be vertically spaced a predetermined distance from each other. To provide the spaced state, a first stopper 1611 and a second stopper 1621 may be disposed on the first rail 1061 and the second rail 1062, respectively. The lower end of the second hanger 1072 may be hung on the first stopper 1611 and thus not be moved downward from the first stopper 1611, and the lower end of the third hanger 1073 may be hung on the second stopper 1621 and thus not be moved downward from the second stopper 1621.

Then, when each of the first hanger 1071, the second hanger 1072, and the third hanger 1073 is disposed at the uppermost position, if the driving part 1030 is rotated in a reverse direction, the horizontal belt 1040 may be rotated in the counterclockwise (clockwise) direction. Thus, each of the first hanger 1071, the second hanger 1072, and the third hanger 1073 may be operated in the opposite way when ascending, thereby to descend.

The first door 1081, the second door 1082, and the third door 1083 are moved together with the first hanger 1071, the second hanger 1072, and the third hanger 1073, respectively.

Hereinafter, constituents for allowing the left and right ends of each of the first door 1081, the second door 1082, and the third door 1083 to ascend or descend at the same time will be described.

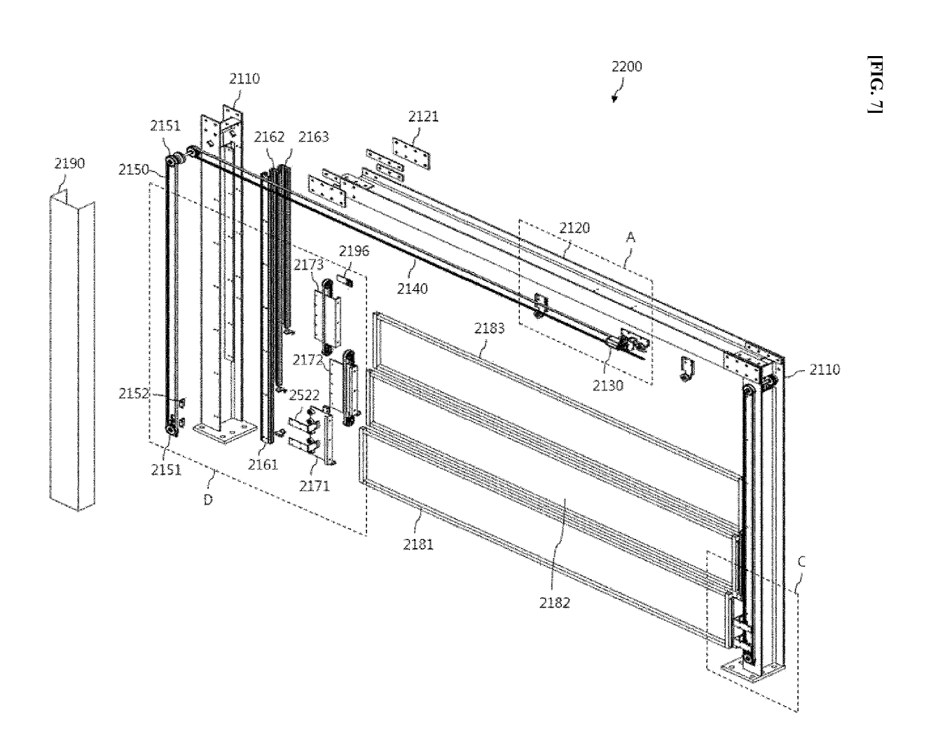

To easily repairing and maintaining the platform screen door 1100 installed according to Embodiment 1 of the present invention, it is preferable that all of the pair of vertical belts 1050 are installed on a side of the platform or a side of the railroad. Here, as seen in FIGS. 1, 3, and 6, the horizontal belt 1040 and the pair of vertical belt 1050 are always rotated in the same direction. Thus, in the left vertical frame 1010 of FIG. 3, the clamp 1052 has to be fixed and coupled to an outer segment 1500 of two vertical segments of the vertical belt 1050 in an opposite direction (or in an outward direction of the outer segment 1500). Also, in the right vertical frame 1010 of FIG. 6, the clamp 1052 has to be fixed and coupled to the outer segment 1500 of the two vertical segments of the vertical belt 1050 in the outward direction (or a direction that is opposite to the outward direction of the outer segment 1500). In this specification, a portion of the left vertical belt 1050 (i.e., the left vertical connector) of the left vertical frame 10101, at which the clamp 1052 is fixed and coupled may be called a ‘first spot’, and a portion of the right vertical belt 1050 (i.e., the right vertical connector) of the right vertical frame 1010, at which the clamp 1052 is fixed and coupled may be called a ‘second spot’.

A housing 1090 of FIG. 1 may serve as a protector for protecting the inner components of the vertical open/close-type platform screen door 1100 according to Embodiment 1. Here, a horizontally extending portion of the housing 1090 may be utilized as a space for advertisement.

Although a balance weight for compensating weights of the first, second, and third hangers 1071, 1072, and 1073 and the first, second, and third doors 1081, 1082, and 1083 is not illustrated in FIGS. 1 to 6, a balance weight as illustrated in FIG. 1 may be installed.

In Embodiment 1 of the present invention, the third hanger 1073, the third rail 1063, and the third door 1083 may be omitted. In this case, the first hanger 1071 and the second hanger 1072 may not be changed in operation state. A portion of claims in this specification may include the contents according to the foregoing Embodiment. Among these, there may be a claim that sets forth the structure in which the third hanger 1073, the third rail 1063, and the third door 1083 are omitted.

### Embodiment 2

Hereinafter, Embodiment 2 of the present invention will be described with reference to FIGS. 2 to 13.

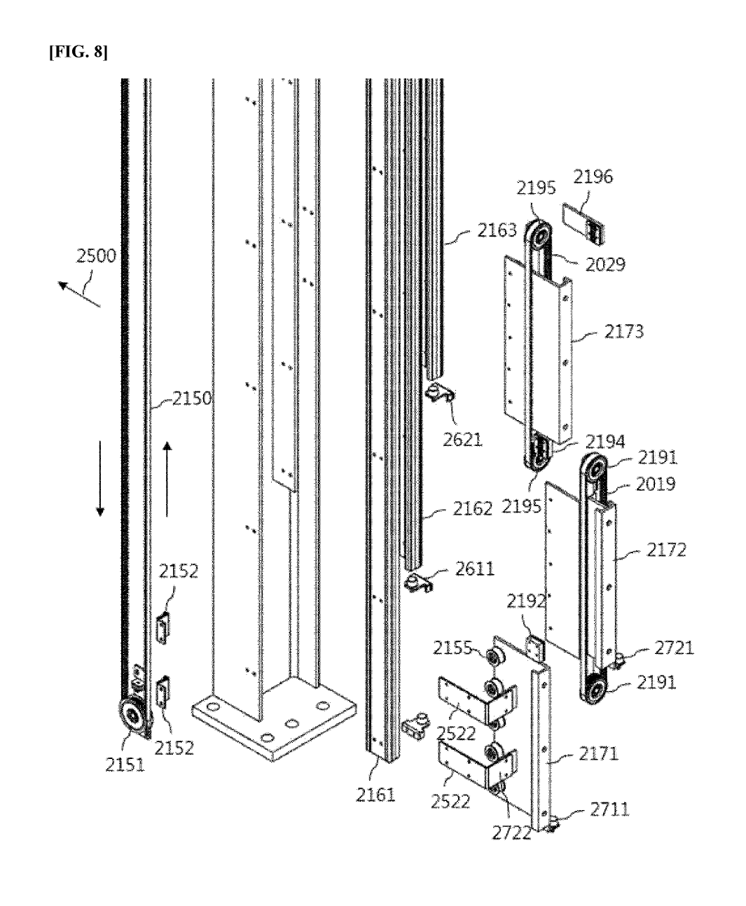

FIG. 7 is an exploded perspective view of a platform screen door 2200 according to Embodiment 2 of the present invention.

FIG. 8 is a partial enlarged view of a portion D of FIG. 7.

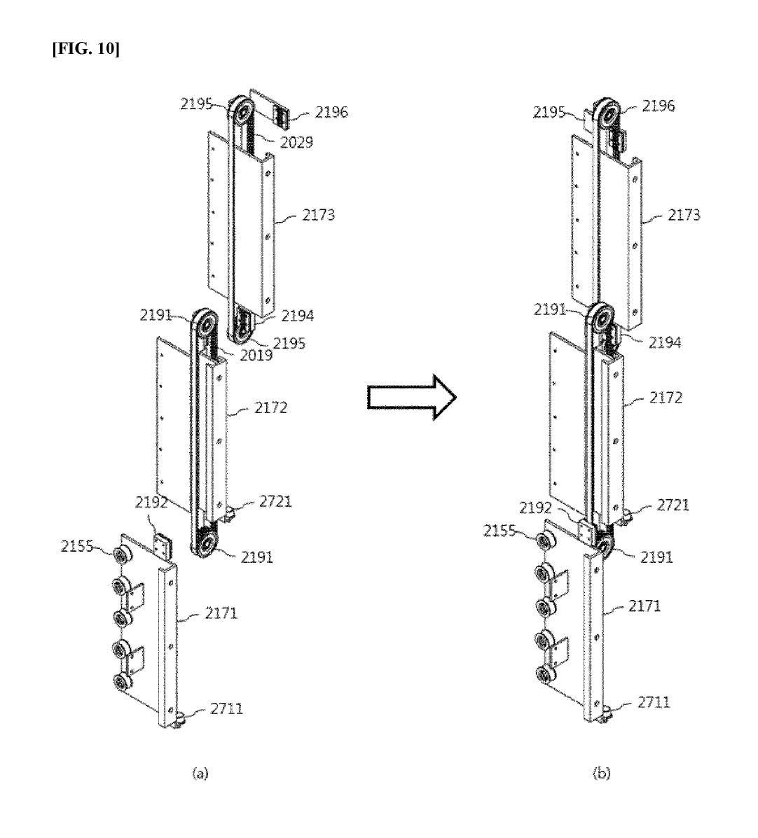

FIG. 9 is a view for explaining a structure of a hanger of FIG. 7.

FIG. 10 is a view for explaining a structure in which the plurality of hangers 2171, 2172, and 2173 of FIG. 7 are coupled to each other. Here, FIG. 10a illustrates a structure before the plurality of hangers 2171, 2172, and 2173 are coupled to each other, and FIG. 10b illustrates a structure after the plurality of hangers 2171, 2172, and 2173 are coupled to each other.

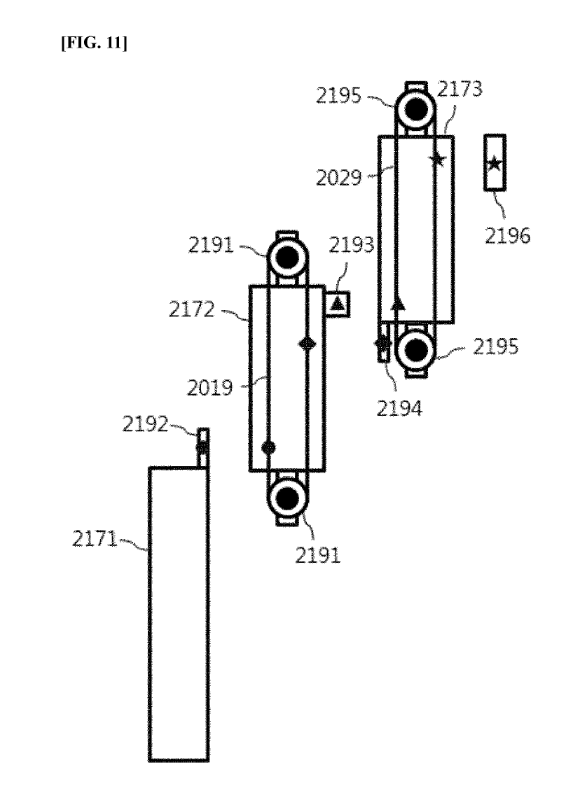

FIG. 11 is a view for explaining a spot at which the plurality of hangers 2171, 2172, and 2173 of FIG. 7 are coupled to each other.

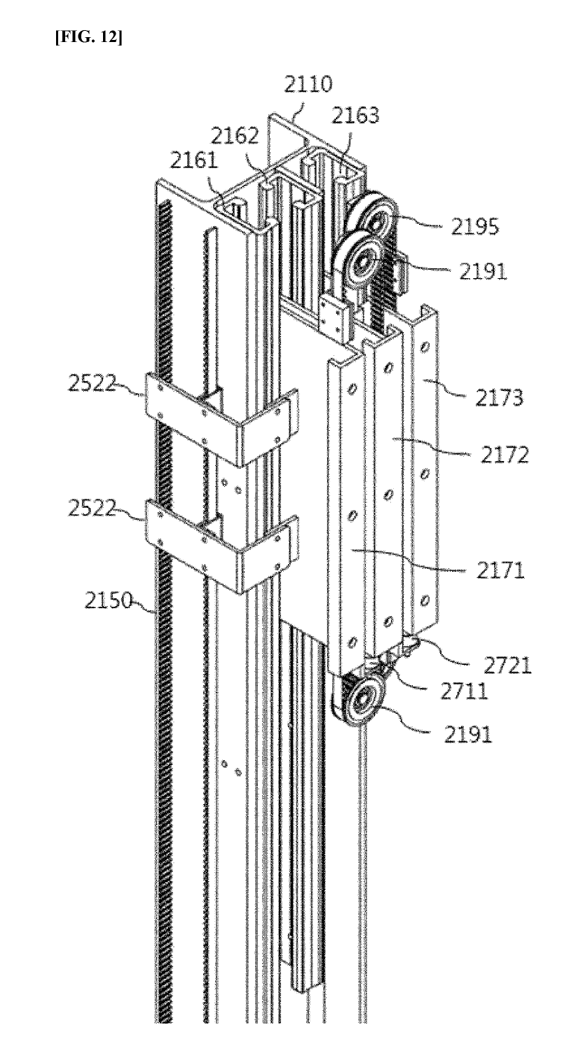

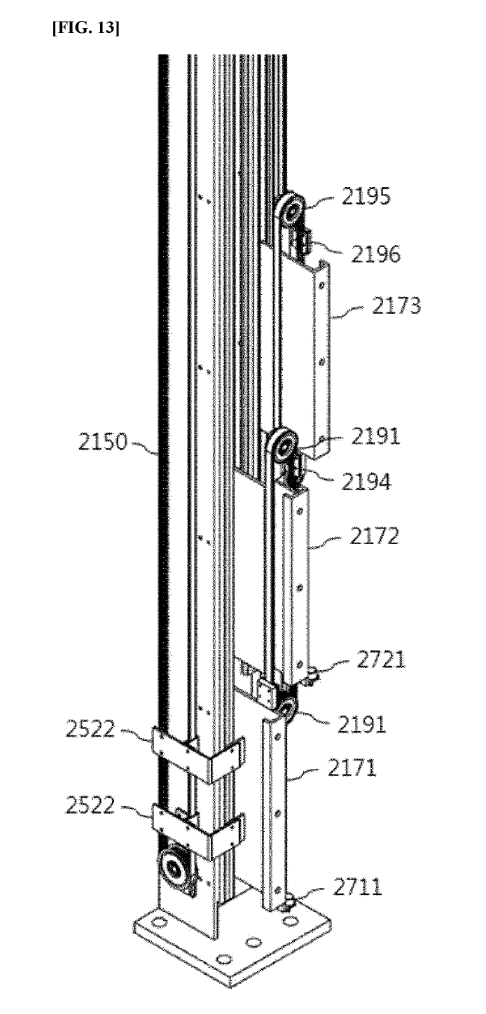

FIG. 12 is a view illustrating a state in which the plurality of hangers 2171, 2172, and 2173 of FIG. 7 ascend to overlap each other.

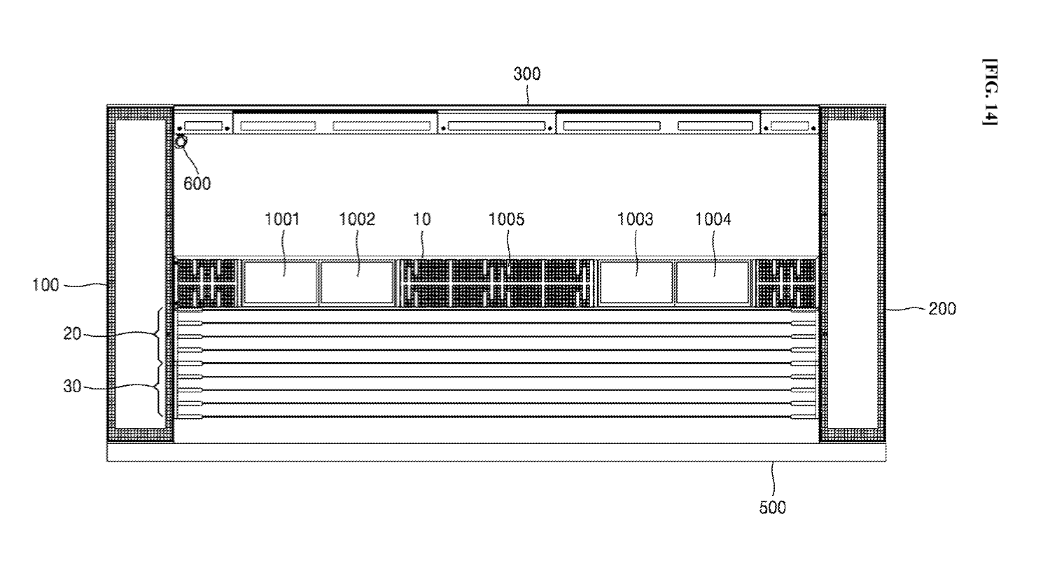

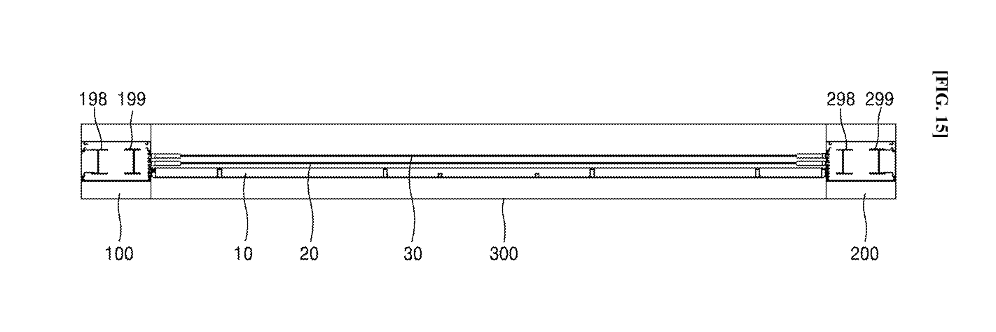

FIG. 13 is a view illustrating a state in which the plurality of hangers 2171, 2172, and 2173 of FIG. 7 are vertically spaced a predetermined distance from each other.

Hereinafter, the platform screen door 2200 according to Embodiment 2 of the present invention will be described with reference to FIGS. 7 to 13.

When comparing the platform screen door 2200 of FIG. 7 according to Embodiment 2 to the platform screen door 1100 of FIG. 1 according to Embodiment 1, the platform screen door 2200 of FIG. 7 may have the same structure as the platform screen door 1100 of FIG. 1 except for a ‘portion D’.

In the platform screen door 2200 according to Embodiment 2 of the present invention, a basic frame of the platform screen door 2100 includes a pair of vertical frames 2110 installed to be spaced apart from each other on a platform and a horizontal frame 2120 connecting upper ends of the pair of vertical frames 2110 to each other. The horizontal frames 2120 and the pair of vertical frames 2110 may be connected to each other by a connection reinforcing member 2121. Here, the pair of vertical frames 2110, the horizontal frame 2120, and the connection reinforcing member 2121 of FIG. 7 may respectively correspond to the pair of vertical frame 1010, the horizontal frame 1020, and the connection reinforcing member 1021 of FIG. 1. Thus, their component, structure, and driving method may also be the same. For example, a torsion bracket 2131, a belt drooping prevention bracket 2141, and a driving part 2130, which are fixed and installed on the horizontal frame 2120 may correspond to the torsion bracket 1031, the belt drooping prevention bracket 1041, and the driving part 1030 of FIG. 1, respectively. Also, a horizontal belt 2140, pulleys 22132, 2142, and 2151, a vertical belt 2150, and a clamp 2152 of FIG. 7 may correspond to the horizontal belt 1040, the pulleys 1032, 1042, and 1051, the vertical belt 1050, and the clamp 1052 of FIG. 1, respectively.

Here, a first rail 2161, a second rail 2162, and a third rail 2163 are disposed on the vertical frame 2110. A first hanger 2171, a second hanger 2172, and a third hanger 2173 may be respectively coupled to the rail 2161, the second rail 2162, and the third rail 2163 and then be vertically moved. For this, at lest one roller 2155 may be coupled to each of the first hanger 2171, the second hanger 2172, and the third hanger 2173, and a shaft of the roller 2155 may be coupled to a roller hole 2166.

One left vertical frame 2110 and one right vertical frame 2110 may be coupled to each of the first hanger 2171, the second hanger 2172, and the third hanger 2173. A first door 2181, a second door 2182, and a third door 2183 may be coupled between the pair of first hangers 2171, between the pair of second hangers 2172, and between the pair of third hangers 2173, respectively.

Here, at least one door connection hole 2188 may be defined in each of the hanger 2171, the second hanger 2172, and the third hanger 2173. Thus, each of the first door 2181, the second door 2182, and the third door 2183 may be coupled to the door connection hole 2188 defined in each of the hanger 2171, the second hanger 2172, and the third hanger 2173.

A pulley shaft 2723 for a pulley 2191 may be disposed on each of upper and lower ends of the second hanger 2172. The pair of pulleys 2191 may be rotatably coupled to the pair of pulley shafts 2723. Also, a belt 2019 may be coupled to contact an outer circumferential surface of each of the pair of pulleys 2191.

A pulley shaft 2724 for a pulley 2195 may be disposed on each of upper and lower ends of the third hanger 2173. The pair of pulleys 2195 may be rotatably coupled to the pair of pulley shafts 2724. Also, a belt 2029 may be coupled to contact an outer circumferential surface of each of the pair of pulleys 2195.

Here, in this specification, the upper pulleys 2191 and 2195 of the pair of pulleys 2191 and 2195 may be called ‘pulleys’, and the lower pulleys 2191 and 2195 may be called ‘moving pulleys’.

As illustrated in FIGS. 10a, 10b, and 11, a first coupling part 2192 may be disposed on an upper end of the first hanger 2171, a second coupling part 2193 may be disposed on an upper end of the second hanger 2172, a third coupling part 2194 may be disposed on a lower end of the third hanger 2173, and a fourth coupling part 2196 may be disposed on a portion of the vertical frame 2110. Here, the first coupling part 2192 may be fixed and coupled to one portion of the belt 2019, the second coupling part 2193 may be fixed and coupled to one portion of the belt 2029, the third coupling part 2194 may be fixed and coupled to the other portion of the belt 2019, and the fourth coupling part 2196 may be fixed and coupled to the other portion of the belt 2029.

Hereinafter, movement principles of the hanger 2171, the second hanger 2172, and the third hanger 2173 according to the operation of the driving part 2130 will be described according to Embodiment 2 of the present invention.

When the driving 2130 is rotated, the horizontal belt 2140 is rotated in the clockwise (counterclockwise) direction. Thus, the pair of vertical belts 2150 coupled to the left vertical frame 2110 and the right vertical frame 2110 may also be rotated in the clockwise (counterclockwise) direction. The clamp 2152 fixed and coupled to the vertical belt 2150 is moved along the vertical belt 2150. The first hanger 2171 fixed and coupled to the clamp 2152 through the coupling piece 2522 and the clamp 2722 is moved in the same direction as the clamp 2152.

Here, since the first coupling part 2192 of the first hanger 2171 is fixed and coupled to one portion of the belt 2019, the second coupling part 2193 of the second hanger 2172 is fixed and coupled to the belt 2029, third coupling part 2194 of the third hanger 2173 is fixed and coupled to the other portion of the belt 2019, the second hanger 2172 coupled to the belt 2019 through the pulley 2191 and the third hanger 2173 coupled to the belt 2029 through the pulley 2195 may be moved in the same direction as the first hanger 2171. Here, since the pair of pulleys 2191 and the other pair of pulleys 2195 serve as moving pulleys (i.e., movable pulleys), a vertical moving speed of the first hanger 2171, a vertical moving speed of the second hanger 2172, and a vertical moving speed of the third hanger 2173 may have a ratio of 3:2:1. Here, the lower pulley 2191 of the pair of pulleys 2191 and the lower pulley 2195 of the other pair of pulleys 2195 may serve as the moving pulleys. Thus, when each of the first, second, and the third hangers 2171, 2172, and 2173 are disposed at the lowermost position, vertical central portions of the first, second, and third hangers 2171, 2172, and 2173 are vertically spaced a predetermined distance from each other. Thus, as the first, second, and third hangers 2171, 2172, and 2173 ascend upward, the distance between the vertical central portions may be reduced.

A first protrusion 2711 is disposed on the lower end of the first hanger 2171. Since the first and second hangers 2171 and 2172 are coupled to each other by the above-described moving pulley (e.g., the pulley 2191), the first hanger 2171 may ascend or descend at a speed that is 3/2 times that of the second hanger 2172. Here, when the first protrusion 2711 is hung on the lower end of the second hanger 2172, the first and second hangers 2171 and 2172 may ascend at the same speed. Thus, the first hanger 2171 does not ascend up to a height that is greater than that of the second hanger 2172.

Also, a second protrusion 2721 is disposed on the lower end of the second hanger 2172. When the second hanger 2172 ascends up to a predetermined height, the second protrusion 2721 is hung on the lower end of the third hanger 2173. Here, the third hanger 2173 may be coupled to the second hanger 2172 to ascend at the same speed as the second hanger 2172.

FIG. 12 illustrates a state in which the first protrusion 2711 is hung on the lower end of the second hanger 2172, and the second protrusion 2721 is hung on the lower end of the third hanger 2172. At this time, the first hanger 2171, the second hanger 2172, and the third hanger 2173 may ascend in a mutually overlapping state.

On the other hand, when each of the first hanger 2171, the second hanger 2172, and the third hanger 2173 is disposed at the lowermost position, the first hanger 1071, the second hanger 1072, and the third hanger 1073 may be maintained to be vertically spaced a predetermined distance from each other as illustrated in FIG. 13. To provide the spaced state, a first stopper 2611 and a second stopper 2621 may be disposed on the first rail 2061 and the second rail 2062, respectively. The lower end of the second hanger 2072 may be hung on the first stopper 2611 and thus not be moved downward from the first stopper 2611, and the lower end of the third hanger 2073 may be hung on the second stopper 2621 and thus not be moved downward from the second stopper 2621.

Then, when each of the first hanger 2171, the second hanger 2172, and the third hanger 2173 is disposed at the uppermost position, if the driving part 2130 is rotated in a reverse direction, the horizontal belt 2140 may be rotated in the counterclockwise (clockwise) direction. Thus, each of the first hanger 2171, the second hanger 2172, and the third hanger 2173 may be operated in the opposite way when ascending, thereby to descend.

The first door 2181, the second door 2182, and the third door 2183 are moved together with the first hanger 2171, the second hanger 2172, and the third hanger 2173, respectively.

### Embodiment 3

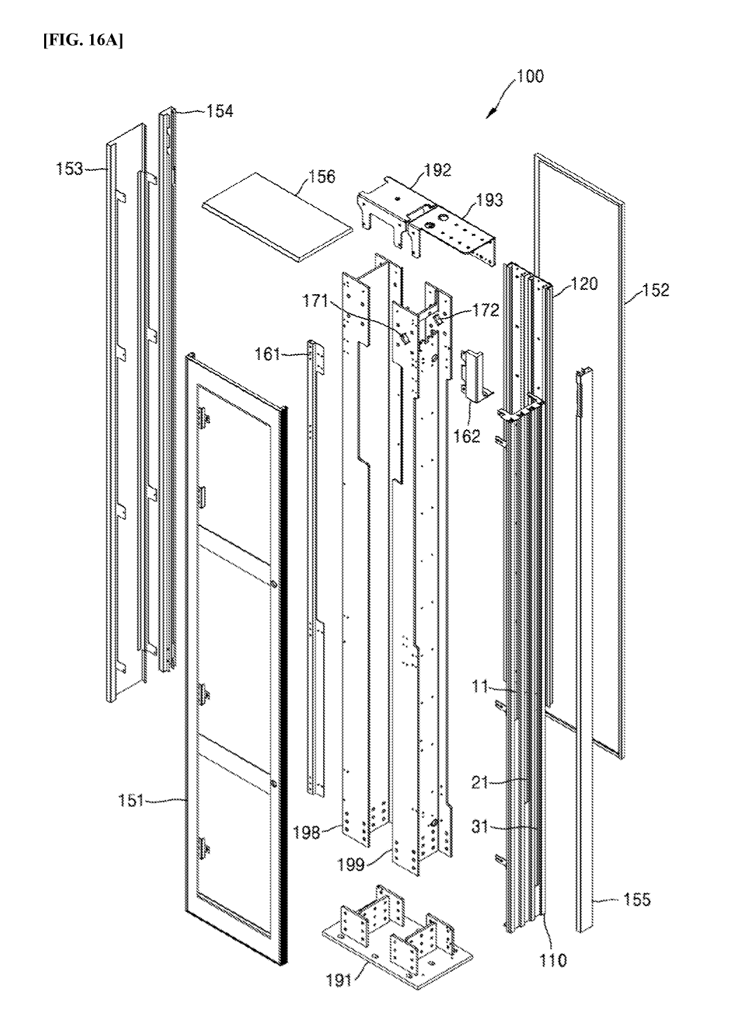

Hereinafter, a platform screen door according to Embodiment 3 of the present invention will be described with reference to FIGS. 14 to 19.

FIG. 14 is a front view of a platform screen door according to an embodiment of the present invention.

[Overall Configuration of Platform Screen Door]

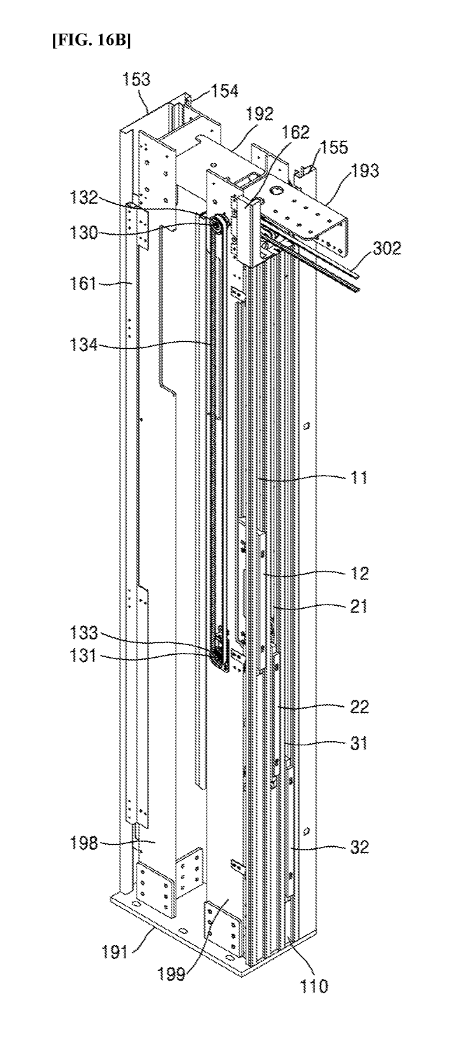

Hereinafter, an overall configuration of the platform screen door according to Embodiment 3 of the present invention will be described with reference to FIGS. 14 and 15.

The platform screen door according to Embodiment 3 of the present invention may include first and second vertical frames 100 and 200 installed on a platform 500 and a horizontal frame 300 connecting upper ends of the first and second vertical frames 100 and 200 to each other. In this specification, the first vertical frame 100 may be called a ‘first frame’ or ‘left vertical frame’, and the second vertical frame 200 may be called a ‘second frame’ or ‘right vertical frame’.

A laser scan sensor 600 may be coupled to a lower end of a left side of the horizontal frame 300. Also, three doors 10, 20, and 30 may be movably and vertically coupled between the left frame 100 and the right frame 200.

[Schematic Configuration of Three Doors]

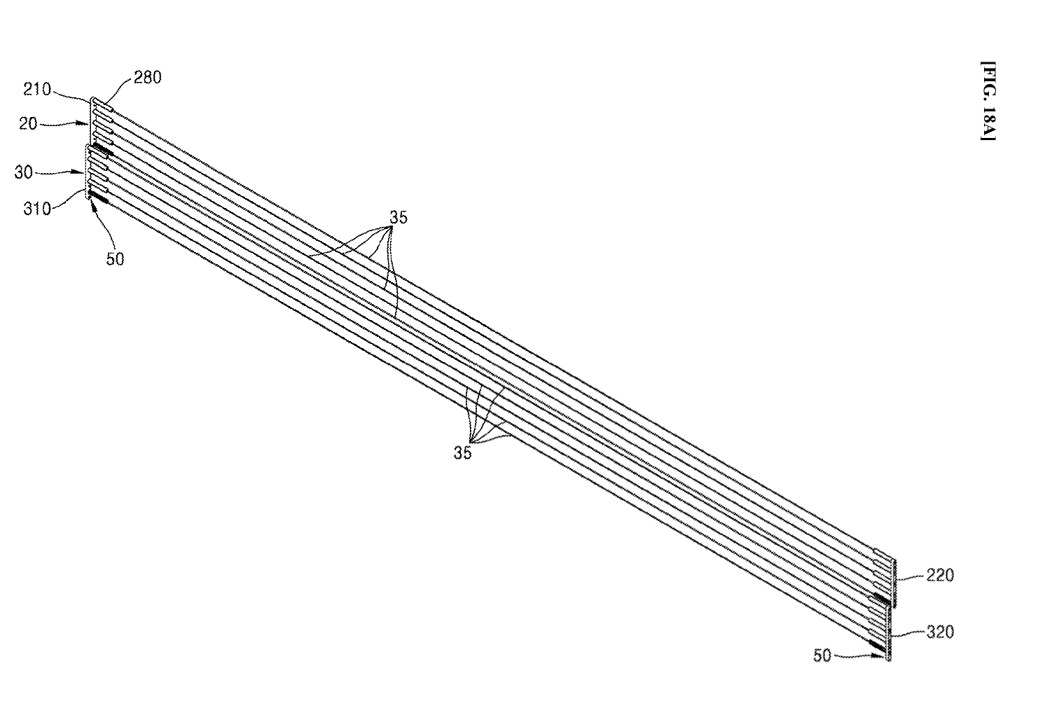

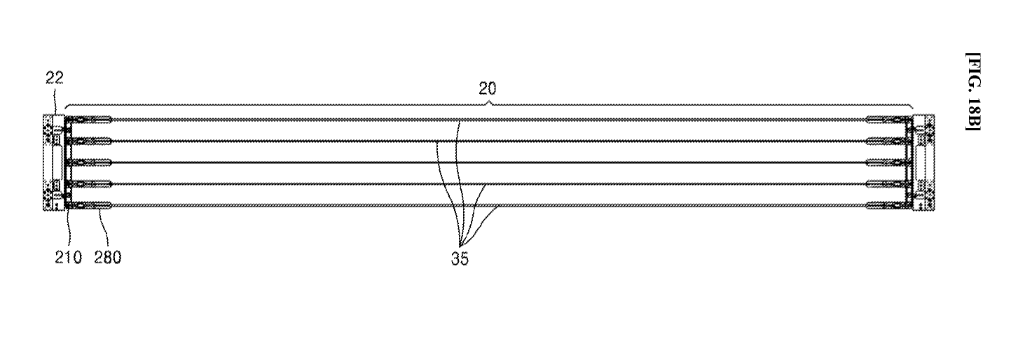

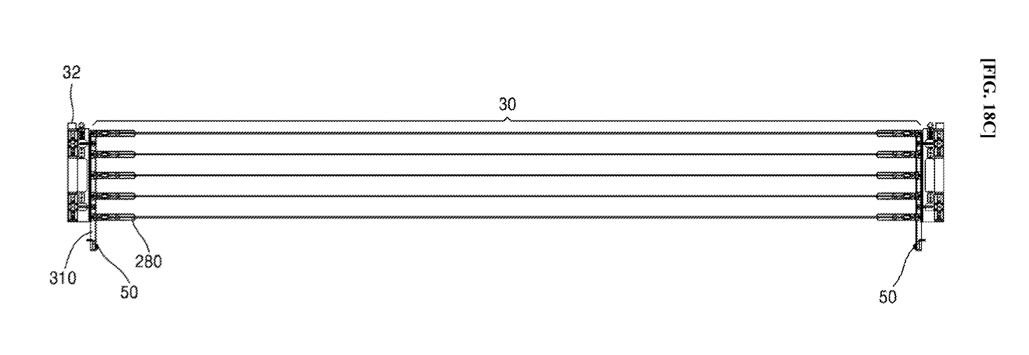

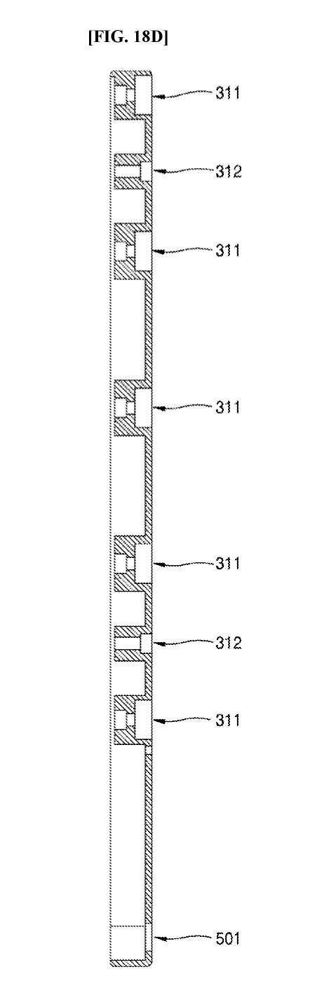

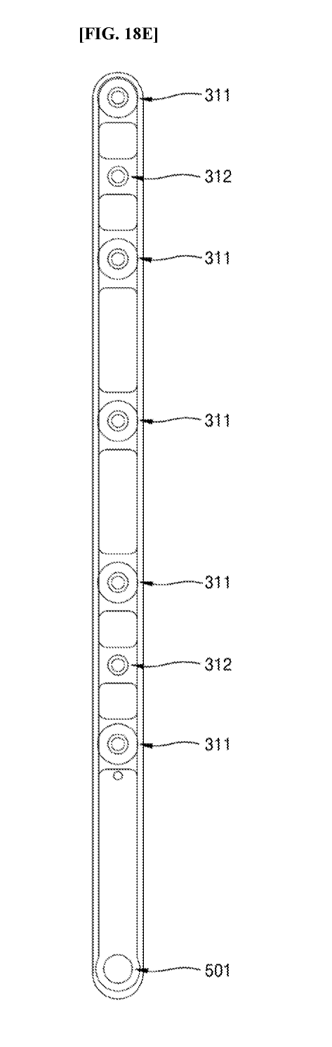

Hereinafter, a schematic configuration of each of three doors according to Embodiment 3 of the present invention will be described with reference to FIGS. 14, 18a, 18b, and 18c.

The third door 10 may have a plate shape. The third door 10 may include a pattern part 1005 for forming advertisement areas 1001 to 1004 and various shapes. Alternatively, the third door 10 may be formed of a finishing material such as glass and polycarbonate. In this specification, the ‘third door’ may be called an ‘upper door’.

A five-line rope 25 extending in a horizontal direction may be disposed on the second door 20. Here, holder parts 210 and 220 may be fixed to both ends of the rope. In this specification, the ‘second door’ may be called an ‘intermediate door’.

In the first door 30, a five-line rope 35 extending in the horizontal direction may be fixed to holder parts 310 and 320. In this specification, the ‘first door’ may be called a ‘lower door’.

[Detailed Configuration of Each of Doors]

Hereinafter, when the first door 30 is described in more detail with reference to FIGS. 18c, 18d, and 18e, an end of the rope 35 may be connected to a first coupling part 311 of the holder part 310. Also, the holder part 310 and a first block 32 may be connected to each other through a second coupling part 312 of the holder part 310. A protection cover 280 for protecting the portion for connecting the ropes 25 and 35 to the holder parts 210, 220, 310, and 320 may be coupled to both ends of each of ropes. Also, an ultrasonic sensor 50 may be disposed on a sensor installation part 501 disposed on a lower end of each of the holder parts 310 and 320 of the first door 30.

When comparing the second door 20 of FIG. 18b to the first door 30, the second door 20 may have the same structure as the first door 30 except that the sensor installation part 501 is not provided to the first door 30. Thus, it may be understood that the second door 20 is constituted and installed through the same method as the first door 30.

As illustrated in FIG. 14, although the third door 10 is different from the second door 20 and the first door 30 in that the third door 10 has a plate shape, but the rope shape, the third door 10 may have a shape similar to those of the second door 20 and the first door 30.

[Description of Relative Positions According to Opening/Closing of Three Doors]

Hereinafter, relative positions of three doors according to opening/closing of the three doors will be described with reference to FIG. 14.

According to Embodiment 3 of the present invention, when the doors 10, 20, and 30 are closed, the third door 10, the second door 20, and the first door 30 may be disposed in order from an upper side. Here, the lowermost rope of the second door 20 may overlap the uppermost rope of the first door 30.

While the doors 10, 20, and 30 are opened, the three doors may vertically ascend at the same time. Here, the three doors 10, 20, and 30 may gradually overlap each other. When the doors are completely opened, the three doors may fully overlap each other. Here, in terms of a moving distance of each of the doors, a moving distance of the second door 20 may be less than that of the third door 10, and a moving distance of the first door 30 may be greater than that of the second door 20.

Detailed Description on Structure of Vertical Frame]

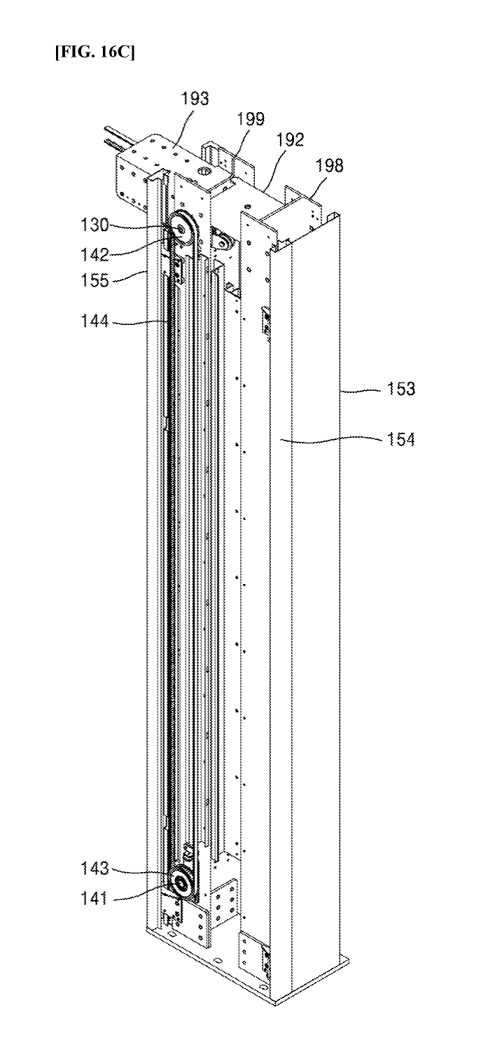

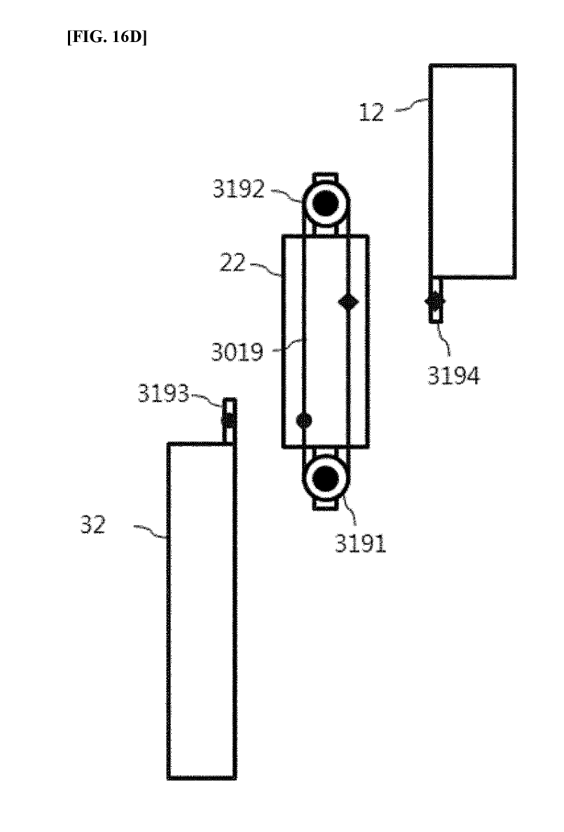

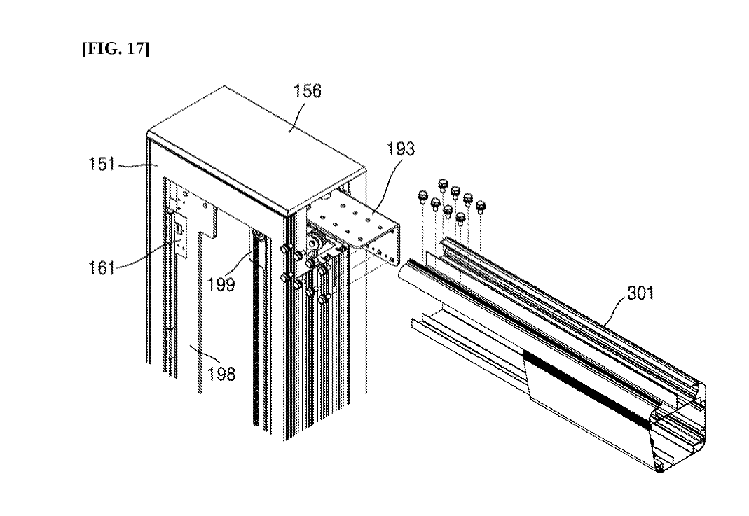

Hereinafter, a structure of the vertical frame will be described in detail with reference to FIGS. 16a, 16b, 16c, and 17.

A base part 191 of the left frame 100 may be directly fixed and connected to a platform 500. A lower end of each of H-beams 198 and 199 may be fixed and coupled to the base part 191. Also, an upper end of each of the H-beams 198 and 199 may be fixed and coupled to a housing 301 of the horizontal frame by connection pieces 192 and 193.

A housing surrounding the H-beams 198 and 199 may include a housing front surface 151, a housing rear surface 152, a housing side surface 153, a housing top surface 156, and housing corners 154 and 155. Here, the ‘housing’ may serve as a protection member for protecting inner components surrounded thereby.

Also, the H-beam 198 may be fixed and coupled to the housing front surface 151 by the connection piece 161, and each of blocks 12, 22, and 32 respectively connected to the first door 30, the second door 20, and the third door 10 may be fixed and coupled to a moving slit part 110.

The slit part 110 may include three slits 11, 21, and 31 that vertically and lengthily extend. The blocks 12, 22, and 32 corresponding to the slits 11, 21, and 31 may be movably coupled within the slits 11, 21, and 31, respectively. The slits 11, 21, and 31 may have lengths different from each other. That is, the third slit 11 may have a length less than that of the second slit 21, and the second slit 21 may have a length less than that of the first slit 13. Also, upper ends of the first, second, and third slits 11, 21, and 31 may be disposed at the same height.

Here, the third block 12 corresponding to the third slit 11 may be coupled to the upper door 10, the second block 22 corresponding to the second slit 21 may be coupled to the intermediate door 20, and the first block 32 corresponding to the first slit 31 may be coupled to the lower door 30.

Holes 171 and 172 for supporting a rotation shaft 130 may be defined one spot of an upper end of the H-beam 199. Here, a second pulley 132 may be rotatably coupled to the rotation shaft 130 on a front surface of the H-beam 199. Also, a rotation shaft 131 may be installed on an intermediate end of the H-beam 199, and a second pulley 133 may be rotatably coupled to the rotation shaft 131. The second pulley 132 and the second pulley 133 may have the same diameter. Here, a second vertical connector (a second vertical belt) 134 may be coupled to the pair of second pulleys 132 and 133. Also, one spot of the second vertical connector 134 may be fixed and connected to the third block (the upper block) 12.

Here, the pulley 142 may be rotatably coupled to the rotation shaft 130 on a rear surface of the H-beam 199. Also, a rotation shaft 141 may be installed on a lower end of the H-beam 199, and a pulley 143 may be rotatably coupled to the rotation shaft 141. The pulley 142 and the pulley 143 may have the same diameter. In an embodiment of the present invention, a circumferential length of the pulleys 142 and 143 may be three times of that of the second pulleys 132 and 133. Here, a vertical connector (a vertical belt) 144 may be coupled to the pair of pulleys 142 and 143. Also, one spot of the vertical connector 144 may be fixed and connected to the first block (the lower block) 32.

[Movement Mechanism of First Block, Second Block, and Third Block]

Hereinafter, movement mechanism of the first block, the second block, and the third block will be described with reference to FIGS. 16b and 16c.

A movement principle of the second vertical connector 134 may be described as follows. First, the horizontal belt 302 may be rotated by an operation of a driving part (e.g., reference numeral 1030 of FIG. 2) installed in the horizontal frame 300. Here, the horizontal belt 302 may rotate the rotation shaft 130. The rotation shaft 130 may rotate the second pulley 132. The second pulley 132 may rotate the second vertical connector 134. The second vertical connector 134 may rotate the second pulley 133. When the one spot is vertically moved by the second vertical connector 134 connected to the third block 12, the third block 12 may be vertically moved.

The first block 32 may be fixed and connected to the one spot of the vertical connector 144. The first block 32 may be vertically moved according to the rotation of the vertical connector 144. Here, the second pulley 132 and the pulley 142 may be connected to the same rotation shaft 130 and thus rotated at the same angular velocity. For example, when the second pulley 132 has a circumferential length that is ½ of that of the pulley 142, a linear velocity of the second vertical connector 134 connected to the second pulley 132 may be ½ of that of the vertical connector 144 connected to the pulley 142.

For example, in an embodiment, the first block 32, the second block 22, and the third block 12 may be moved by distances 1800 mm, 1350 mm, and 900 mm from the lowermost end that is fully closed to the uppermost end that is fully opened.

Here, referring to FIG. 16d, the second block 22 may be connected the first block 32 through a moving pulley 3191. The moving pulley 3191 and the first pulley 3192 are fixedly installed on the second block 22, and the first connector (belt) 3019 is wound around the moving pulley 3191 and the first pulley 3192. A portion (a first coupling part 3193) of the first block 32 may be fixed and coupled to one spot (that is expressed in a black circular shape) of the first connector 3019, and a portion 3194 disposed on the third block 12 may be fixed and coupled to the other spot (that is expressed in a black diamond shape) of the first connector 3019. Here, when the second vertical connector 144 vertically moves the first block 32, the first block 32 may vertically move the second block 22 through the first connector 3019. Here, for example, when the third block (the upper block) is vertically moved by a distance L, the second block (the intermediate block) 22 may be vertically moved by a distance 1.5 L.

In summary of the above-described movement mechanism, vertical moving speeds of the third block 12, the second block 22, and the first block 32 may be designed to have a ratio of 1:1.5:2.

Also, the third block 12, the second block 22, and the first block 32 may be guided and moved by a slit part 110 and a rail disposed on the rail part 120. The rail part 120 may serve as a guide part along which a weight (not shown) is moved.

[Structures of First Block, Second Block, and Third Block]

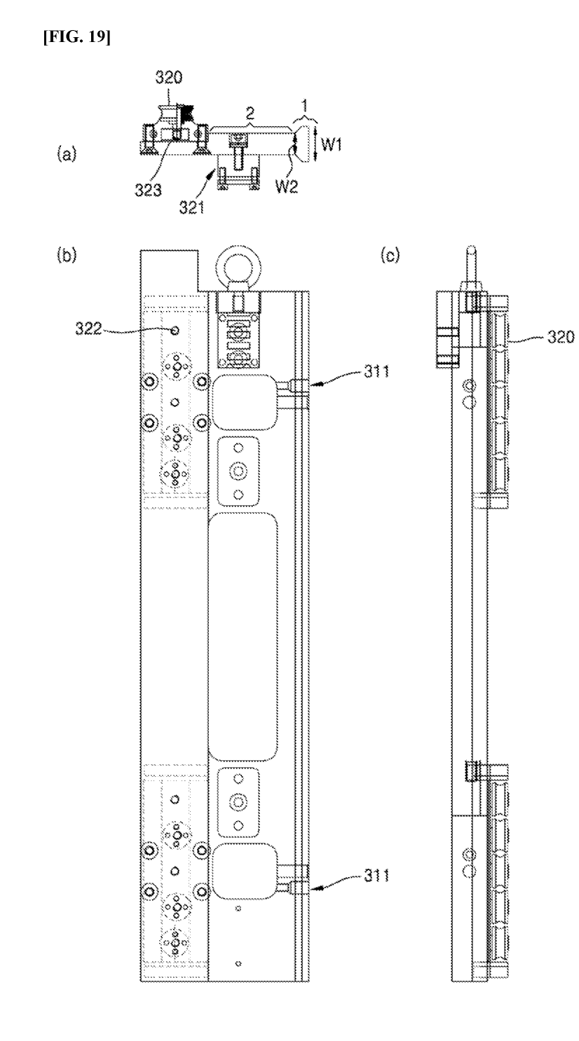

Hereinafter, structures of the first block, the second block, and the third block will be described with reference to FIG. 19. Here, the structure of the first block will be mainly described as an example.

FIGS. 19(a), 19(b), and 19(c) are plan, front, and side views of the first block 32, respectively.

A hole 322 for supporting a rotation shaft 323 may be defined in the first block 32. FIG. 19 illustrates an example in which total 10 rotation shafts 323 and total 10 holes 322 are provided. The holes 322 may be provided for coupling a wheel 320. Here, although the 10 holes 322 are defined in a vertical direction, reference numeral may be given to only one hole.

Also, the wheel 320 may be coupled to each of the rotation shafts 323 so that the wheel 320 is moved along the rail. Although all 10 wheels 320 are illustrated in FIG. 18(c), for convenience of description, the wheels 320 may not illustrated or be expressed as a dotted line in FIG. 19(b).

A coupling part 311 disposed on the first block 32 may be coupled to a coupling part 312 (see FIG. 18e) disposed on a holder part 310 of the first door 30 by using a coupling member.

Referring to FIG. 19(a), the first block 32 may include a head part 1, a body part 2, a wheel 320 connected to an end of a left side of the body part 2, and a belt connection part 321 connected to a center of an upper portion of the body part 2. The belt connection part 321 may be fixed and coupled to one end of the above-described second vertical connector 134. The head part 1 and the body part 2 may be integrated with each other.

The first block 32 may be coupled to the vertical frame through following processes. First, the body part 2 may be inserted into a first slit 31. Here, the head part 1 may be hung on an edge of the first slit 31. Then, the wheel 320 and the belt connection part 321 may be coupled to the body part 2. Then, the belt connection part 321 may be fixed and coupled to the second vertical connector 134. Here, the wheels 320 may be aligned to correspondingly contact the rail part 120.

Here, the head part 1 may have a first width W1 greater than a second width W2 of the body part 2. Also, the first width W1 may be greater than a third width of the first slit, and the second width W2 may be less than the third width.

[Description on Sensor Installed on Third Door]

As described above, a sensor 50 may be installed on a lower end of the first door 30, i.e., a lower end of the holder part 310. The sensor 50 may be provided in a pair on left and right sides. When the first door 30 descends, the sensor 50 may detect a person's head, which may exist directly under the first door 30, to provide a signal for emergency stopping an operation of the screen door. For example, the sensor 50 may be an ultrasonic type sensor. Here, other technologies may be adopted as a specific detecting manner.

Here, the sensor 50 may be installed inside the first slit 31, i.e., the vertical frame. On the other hand, the sensor may be installed outside the first slit 31, i.e., the vertical frame. However, since dusts may be introduced into the vertical frame through the first slit 31, it may be preferable that the first slit 31 has a small width. According to embodiments, a brush for preventing dusts from being introduced may be installed on the first slit 31.

However, if the sensor 50 has a large size, when the sensor 50 is installed inside the first slit 31, a signal to be transmitted from or received into the sensor 50 may be blocked by an edge portion of the first slit 31 because the first slit 31 has a narrow width.

Thus, in an embodiment of the present invention, for solving the above-described problem, the sensor 50 may be installed outside the first slit 31, i.e., the vertical frame.

In the structure of the platform screen door according to an embodiment of the present invention, since the holder part 310 is disposed outside the first slit 31, the sensor 50 may be installed on a sensor installation part 501 provided on a lower end of the holder part 310. A wired cable connected to the sensor 50 may extend through the insides of the horizontal frame and the vertical frame of the platform screen door and be connected to a control part through the first slit 31.

### Embodiment 4

Hereinafter, a platform screen door according to Embodiment 4 of the present invention will be described with reference to FIGS. 7 to 13.

The platform screen door includes: a main body including a pair of vertical frames 2110; first and second doors 2181 and 2182 disposed between the pair of vertical frames 2110; a first moving pulley 2191 coupled to the second door 2182 to vertically move the second door 2182; a first connector 2019 for driving the first moving pulley 2191; and driving assemblies 1008 and 1009 installed on the main body to drive the first connector 2019. Here, the first door 2181 may be fixed and coupled to one spot of a driving segment of the first connector 2019. For example, the one spot of the driving segment of the first connector 2019 may represent a left portion of the first connector 2019.

Here, the platform screen door according to Embodiment 4 of the present invention may further include a first pulley 2191. The first pulley 2191 may be rotatably coupled to the second door 2181. The first connector 2019 may be a belt for connecting the first moving pulley 2191 to the first pulley 2191. Also, the second door 2182 may receive vertical force from the first door 2181 through the first moving pulley 2191. Here, the first door 2181 and the second door 2182 may be moved along rails 2161 and 2162 provided on the vertical frame 2110.

The platform screen door according to Embodiment 4 of the present invention may further includes: a horizontal frame disposed on upper portions of the pair of vertical frames 2110; and one driving part installed on the main body to drive the driving assemblies 1008 and 1009 through a horizontal connector 2140. Here, the driving assembles 1008 and 1009 may include: a left driving assembly 1008 installed on a left vertical frame 2110 of the pair of vertical frames 2110 to vertically move a left end of the first door 2181; and a right driving assembly 1009 installed on a right vertical frame 2110 of the pair of vertical frames 2110 to vertically move a right end of the first door 2181. Here, the left driving assembly 1008 and the right driving assembly 1009 may be driven at the same time by the one driving part. Here, the horizontal connector 2140 may include a belt, a chain, or a rope. The horizontal connector 2140 may be disposed to extend along the horizontal frame 2120, and a pulley 1042 for preventing the horizontal connector 2140 from drooping may be installed on the horizontal frame 2120. Here, the driving assemblies 1008 and 1009 may include a pair of pulleys 2151, a vertical connector 2150 rotated by the pair of pulleys 2151, a first rail 2161 disposed on the vertical frame, and a first hanger 2171 for fixing and coupling a portion of the vertical connector 2150 to the first door 2181 and vertically moved along the first rail 2161. Here, a rotation shaft of the upper first pulley 2151 of the pair of pulleys 2151 may be coupled to the horizontal connector 2149 and thus rotated by the horizontal connector 2140.

The platform screen door according to Embodiment 4 of the present invention may further include: a first hanger 2171 connected to a left side of the first door 2181; and a second hanger 2172 connected to a left side of the second door 2182 and including the first moving pulley. Here, the first connector 2019 may transmit the vertical force from the first hanger 2171 to the second hanger 2172 through the first moving pulley 2191. Here, a first coupling part 2192 disposed on the first hanger 2171 may be fixed and coupled to a portion of the first connector 2019. Here, the left driving assembly 1009 may include a left vertical connector 2150 and a left first hanger 2171 for fixing and coupling a portion of the left vertical connector 2150 to a left end of the first door 2181. Also, the right driving assembly 1009 may include a right vertical connector 2150 and a right first hanger 2171 for fixing and coupling a portion of the right vertical connector 2150 to a right end of the first door 2181. Here, the left end of the first door 2181 may be fixed and coupled to a first spot of the left vertical connector 2150, and the right end of the first door 2181 may be fixed and coupled to a second spot of the right vertical connector 2150. Here, the first spot and the second spot may be selected to be always directed in the same direction. Here, all of the left driving assembly 1008 and the right driving assembly 1009 may be disposed on a side of the platform or the railroad.

### Embodiment 5

Hereinafter, a platform screen door according to Embodiment 5 of the present invention will be described with reference to FIGS. 7 to 13.

A platform screen door according to Embodiment 5 of the present invention includes: first, second, and third doors 2181, 2182, and 2183 disposed between a pair of vertical frames 2110; first, second, and third hangers 2171, 2172, and 2173 respectively connected to left and side sides of the first, second, and third doors 2181, 2182, and 2183; a first moving pulley 2191 coupled to the second hanger 2172 to vertically move the second door 2182; a second moving pulley 2195 coupled to the third hanger 2173 to vertically move the third door 2183; and first and second connectors 2019 and 2029 for respectively driving the first and second moving pulleys 2191 and 2195.

The first hanger 2171 may be fixed and coupled to one spot of the first driving segment of the first connector 2019, and the second hanger 2172 may be fixed and coupled to one spot of the second driving segment of the second connector 2029. For example, the one spot of the first driving segment of the first connector 2019 may represent a left portion of the first connector 2019, and the one spot of the second driving segment of the second connector 2029 may represent a left portion of the second connector 2029.

The platform screen door according to Embodiment 5 of the present invention may further include a first pulley 2191. The first pulley 2172 may be rotatably coupled to the second hanger 2172. The first connector 2019 may be a belt for connecting the first moving pulley 2191 to the first pulley 2191. Also, the platform screen door according to Embodiment of the present invention may further include a second pulley 2195. The second pulley 2195 may be rotatably coupled to the third hanger 2173, and the second connector 2029 may be a belt for connecting the second moving pulley 2195 to the second pulley 2195.

Here, a first coupling part 2192 disposed on the first hanger 2171 may be fixed and coupled to a portion of the first connector 2019, and a second coupling part 2194 disposed on the third hanger 2173 may be fixed and coupled to a portion of the second connector 2029. Here, the first hanger 2171, the second hanger 2172, and the third hanger 2173 may be moved along rails 2161, 2162, and 2163 provided on the vertical frame 2110.

### Embodiment 6

Hereinafter, a platform screen door according to Embodiment 6 of the present invention will be described with reference to FIGS. 14 to 19.

The platform screen door according to Embodiment 6 includes: a main body including a pair of vertical frames 100 and 200; first and second doors 30 and 20 disposed between the pair of vertical frames 100 and 200; a moving pulley 3191 coupled to the second door 20 to vertically move the second door 20; a first connector 3019 for driving the moving pulley 3191; and a driving assembly 4100 installed on the main body to drive the first connector 3019. Here, the first door 30 may be fixed and coupled to one spot of the driving assembly 4100 of the first connector 3019. Here, the term ‘fixed and coupled’ may be concept including a structure in which the first door 30 is a portion of the driving assembly 4100.

In this specification, the ‘horizontal connector’ and the ‘vertical connector’ may be called a ‘first connector’ and a ‘second connector’, respectively. Also, it may be unnecessary that the ‘horizontal connector’ has to lengthily extend in the horizontal direction, and the ‘vertical connector’ has to lengthily extend in the vertical direction.

In the above-described various embodiments, although each of the door leafs moved in the vertical direction has the plate shape or rope shape, the present embodiment is not limited thereto. For example, the door leafs may include at least one long rod that extends in the left/right direction. Also, each of the door leafs may be coupled to at least one structure such as the plate, the rope, and the rod. Also, a surface of each of the door leafs may be formed of a finishing material such as glass and polycarbonate.

The description of the present invention is intended to be illustrative, and those with ordinary skill in the technical field of the present invention pertains will be understood that the present invention can be carried out in other specific forms without changing the technical idea or essential features. Hence, the real protective scope of the present invention shall be determined by the technical scope of the accompanying claims.

### DESCRIPTION OF SYMBOLS

### FIGS. 14 to 19

10: Third door 20: Second door
30: First door 11: Third slit
21: Second slit 31: First slit
12: Third block 22: Second block
32: First block 3193: First coupling part
100: Vertical frame (left side) 200: Vertical frame (right side)
300: Horizontal frame 302: Horizontal connector
130: Rotation shaft 142, 143: Pulley
144: Vertical connector, vertical belt 132, 133: Second pulley
134: Second vertical connector, second vertical belt 1030: Driving part (FIG. 2)
1042: Pulley 3019: First connector, belt
3191: Moving pulley 3192: First pulley
4100: Driving assembly (32, 142, 143, 144, 130, 302, 1030)

### FIGS. 1 to 13

1008: Left driving assembly (Assembly of (1071, 1061, 1051, 1052, 1050, 1522) or (2171, 2161, 2151, 2152, 2150, 2522))
1009: Right driving assembly ((Assembly of 1071, 1061, 1051, 1052, 1050, 1522) or (2171, 2161, 2151, 2152, 2150, 2522))

1. A platform screen door comprising:
a main body comprising a pair of vertical frames (100, 200);
a first door (30) and a second door (20), which are disposed between the pair of vertical frames;
a moving pulley (3191) coupled to the second door to vertically move the second door;
a first connector (3019) driving the moving pulley; and
a driving assembly (4100) driving the first connector, the driving assembly being installed on the main body,
wherein the first door is fixed and connected to one spot of the driving assembly of the first connector.

2. The platform screen door of claim 1, further comprising a first pulley (3192),
wherein the first pulley is rotatably coupled to the second door, and
the first connector comprises a belt for connecting the moving pulley to the first pulley.

3. The platform screen door of claim 1, wherein the second door receives vertical force from the first door through the moving pulley.

4. The platform screen door of claim 1, wherein the first door and the second door are moved along a rail provided on the vertical frame.

5. The platform screen door of claim 1, further comprising:
a horizontal frame (300) disposed on upper portions of the pair of vertical frames; and
one driving part installed on the main body to drive the driving assembly through the horizontal connector (302),
wherein the driving assembly comprises:
a left driving assembly installed on a left vertical frame (100) of the pair of vertical frames to vertically move a left end of the first door; and
a right driving assembly installed on a right vertical frame of the pair of vertical frames to vertically move a right end of the first door,
wherein the left driving assembly and the right driving assembly are driven at the same time by the one driving part.

6. The platform screen door of claim 5, wherein the horizontal connector comprises a belt, a chain, or a rope and is disposed to extend along the horizontal frame, and
a pulley (1042) for preventing the horizontal connector from drooping is installed on the horizontal frame.

7. The platform screen door of claim 1, wherein the driving assembly comprises:
a pair of pulleys (142, 143);
a vertical connector (144) rotated by the pair of pulleys;
a first slit (31) defined in the vertical frame; and
a first block (32) for fixing and coupling a portion of the vertical connector to the first door, the first block being vertically moved along the first slit.

8. The platform screen door of claim 7, wherein a rotation shaft (130) of the upper pulley (142) of the pair of pulleys is coupled to the horizontal connector so as to be rotated by the horizontal connector.

9. The platform screen door of claim 1, further comprising:
a first block (32) connected to left and right sides of the first door; and
a second block (22) connected to left and right sides of the second door, the second block comprising a first moving pulley,
wherein the first connector transmits vertical force from the first block to the second block through the moving pulley.

10. The platform screen door of claim 9, wherein a first coupling part (3193) disposed on the first block is fixed and coupled to a portion of the first connector.

11. The platform screen door of claim 5, wherein the left driving assembly comprises:
a left vertical connector (144); and
a left first block (32) for fixing and coupling a portion of the left vertical connector to the left end of the first door, and
the right driving assembly comprises:
a right vertical connector; and
a right first block for fixing and coupling a portion of the right vertical connector to the right end of the first door,
wherein the left end of the first door is fixed and coupled to a first spot of the left vertical connector,
the right end of the first door is fixed and coupled to a second spot of the right vertical connector, and
the first and second spots are selected to be always directed in the same direction.

12. The platform screen door of claim 11, wherein all of the left driving assembly and the right driving assembly are disposed on a side of a platform or a side of a railroad.

13. The platform screen door of claim 1, further comprising:
a third door (10) disposed between the pair of vertical frames;
a pair of second pulleys (132, 133) installed on the pair of vertical frames; and
a second vertical connector (134) rotated by the pair of second pulleys,
wherein, when the platform screen door is closed, the third door is disposed at a position higher than that of the second door, and a first portion of the third door is relatively fixed to a first portion of the second vertical connector so as to be vertically moved according to rotation of the second vertical connector.
